(19) United States
(12) Patent Application Publication
(10) Pub. No.: US 2022/0187751 A1
(43) Pub. Date: Jun. 16, 2022

(54) Imaging System with Measurement of Bending

(71) Applicant: Hewlett-Packard Development Company, L.P., Spring, TX (US)

(72) Inventors: Yuichiro Tomishima, Yokohama (JP); Takahiro Yoshikawa, Yokohama (JP); Tomonori Ueno, Yokohama (JP)

(73) Assignee: Hewlett-Packard Development Company, L.P., Spring, TX (US)

(21) Appl. No.: 17/414,072

(22) PCT Filed: Aug. 25, 2020
(86) PCT No.: PCT/US2020/047737

§ 371 Date: Jun. 15, 2021

(30) Foreign Application Priority Data
Sep. 3, 2019 (JP) 2019-160216

(51) Int. Cl. G03G 15/00

(52) U.S. Cl. CPC G03G 15/5062

(57) ABSTRACT

An imaging system includes a conveyor device to convey a sheet material along a conveyance path, a deformation tolerance portion located along the conveyance path, and a measurement device located in the deformation tolerance portion. The deformation tolerance portion includes a space to accommodate a bending of the conveyed sheet material. The measurement device measures a bending amount of the sheet material.

### BACKGROUND

An imaging apparatus includes, for example, a conveyor device which conveys a sheet, an image carrier on which an electrostatic latent image is formed, a developing device which develops an electrostatic latent image, a transfer device which secondarily transfers a toner image to a sheet, a fixing device which fixes a toner image to a sheet, and a discharging device which discharges a sheet.

### BRIEF DESCRIPTION OF DRAWINGS

FIG. 1 is a schematic diagram illustrating an example imaging apparatus.

FIG. 2 is a schematic side view of an example sheet supply device.

FIG. 3 is a schematic side view of an example stiffness index measurement device.

FIG. 4 is a schematic diagram illustrating a portion of an example stiffness index measurement device.

FIG. 5 is a graph of a bending amount of a sheet material as a function of a basis weight.

### DETAILED DESCRIPTION

Hereinafter, an example imaging system will be described with reference to the drawings. The imaging system may include, for example, an imaging apparatus such as a printer, or in other examples, the imaging system may be a device or mechanism forming part of the imaging apparatus. For example, the imaging system may include a conveyor device, a measurement unit (or measurement device), a developing device, or the like used in or with an imaging apparatus or the like. In the following description, with reference to the drawings, the same reference numbers are assigned to the same components or to similar components having the same function, and overlapping description is omitted.

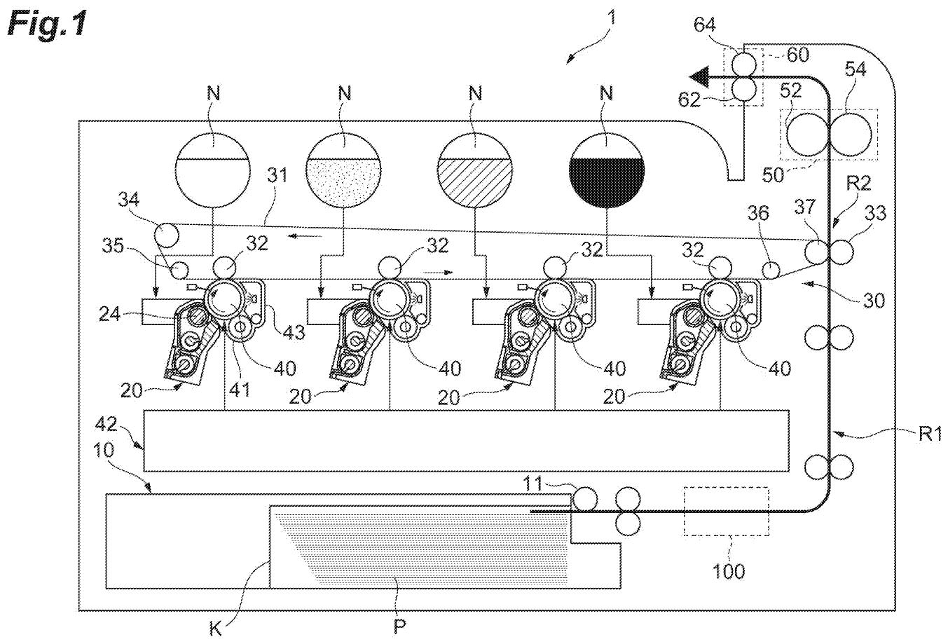

With reference to FIG. 1, an example imaging apparatus 1 forms a color image by using respective colors of magenta, yellow, cyan, and black. The imaging apparatus 1 includes, for example, a sheet supply device (conveyor device) 10 which supplies a sheet (e.g., a paper sheet) P as a sheet material corresponding to a printing medium, a developing device 20 which develops an electrostatic latent image, a transfer device 30 which secondarily transfers a toner image to the sheet P, an image carrier 40 on which an electrostatic latent image is formed, a fixing device 50 which fixes a toner image to the sheet P, and a discharging device 60 which discharges the sheet P.

The sheet supply device 10 conveys, for example, the sheet P on a conveyance path R1 to be supplied to a transfer nip portion R2. The sheet P is stored, for example, in a cassette K while being stacked on a pressing member 16 and is picked up and conveyed by a first roller 11. The sheet supply device 10 allows the sheet P to reach the transfer nip portion R2 through the conveyance path R1, for example, at a timing in which a toner image transferred to the sheet P reaches the transfer nip portion R2.

Four developing devices 20 may be provided for the four colors, respectively. Each developing device 20 includes, for example, a developer carrier 24 which carries a toner on the image carrier 40. The developing device 20 may use a two-element developer including the toner and a carrier, as developer. In the developing device 20, the toner and the carrier are mixed to be adjusted to a targeted mixing ratio so that the toner is dispersed uniformly in the developer. Accordingly, the developer is adjusted to an optimal charging amount. This developer is carried by the developer carrier 24. The developer carrier 24 rotates so that the developer is conveyed to a region facing the image carrier 40. Then, the toner in the developer carried by the developer carrier 24 moves to or transfers to an electrostatic latent image formed on the peripheral surface of the image carrier 40 so that the electrostatic latent image is developed.

The transfer device 30 conveys, for example, a toner image formed by the developing device 20 to the transfer nip portion R2. The transfer device 30 includes, for example, a transfer belt 31 to which a toner image is primarily transferred from the image carrier 40, tension rollers 34, 35, 36, and 37 which tension the transfer belt 31, a primary transfer roller 32 which sandwiches the transfer belt 31 between the primary transfer roller 32 and the image carrier 40, and a secondary transfer roller 33 which sandwiches the transfer belt 31 between the secondary transfer roller 33 and the tension roller 37.

The transfer belt 31 is, for example, an endless belt which moves in a circulating manner by a rotation of the tension rollers 34, 35, 36, and 37. Each of the tension rollers 34, 35, 36, and 37 is a roller which is rotatable about a rotation axis. The tension roller 37 is, for example, a driving roller which rotates about the axis in a driving manner. The tension rollers 34, 35, and 36 are, for example, driven rollers which rotate in a driven manner in accordance with the rotational driving of the tension roller 37. The primary transfer roller 32 presses against the image carrier 40, for example, from the inner peripheral side of the transfer belt 31. The secondary transfer roller 33 is disposed, for example, in parallel to the tension roller 37 with the transfer belt 31 interposed therebetween and presses against the tension roller 37 from the outer peripheral side of the transfer belt 31. Accordingly, the secondary transfer roller 33 forms the transfer nip portion R2 between the secondary transfer roller 33 and the transfer belt 31.

The image carrier 40 may also be referred to as an electrostatic latent image carrier, a photosensitive drum, or the like. Four image carriers 40 are provided for the four respective colors. The image carriers 40 may be spaced apart along the movement direction of the transfer belt 31. For each image carrier 40, the developing device 20, a charging roller 41, an exposure unit (or exposure device) 42, and a cleaning device 43 may be located adjacent (e.g., on the periphery of) the image carrier 40.

In some examples, the charging roller 41 uniformly charges the surface of the image carrier 40 to a predetermined potential. The charging roller 41 moves, for example, in accordance with the rotation of the image carrier 40. The exposure unit 42 exposes, for example, the surface of the image carrier 40 charged by the charging roller 41 in response to an image formed on the sheet P. Accordingly, a potential of a portion exposed by the exposure unit 42 in the surface of the image carrier 40, changes so that an electrostatic latent image is formed. Four developing devices 20 are associated with the four image carriers 40. The four developing devices 20 may develop, for example, the electrostatic latent image with the toner supplied from the four toner tanks N that face the respective developing devices 20, to generate a toner image. The toner tanks N are respectively filled with, for example, the toners of magenta, yellow, cyan, and black. The cleaning device 43 collects the toner remaining on the image carrier 40, for example, after the toner image formed on the image carrier 40 is primarily transferred to the transfer belt 31.

The fixing device 50 fixes to the sheet P, the toner image having been secondarily transferred from the transfer belt 31 to the sheet P, for example, by directing the sheet P to pass through the fixing nip portion for heating and pressing the sheet. The fixing device 50 includes, for example, a heating roller 52 which heats the sheet P and a pressing roller 54 which rotates in a driving manner while pressing against the heating roller 52. The heating roller 52 and the pressing roller 54 are formed in, for example, a cylindrical shape and the heating roller 52 includes a heat source such as a halogen lamp provided therein. A fixing nip portion which is a contact region is provided between the heating roller 52 and the pressing roller 54 and the toner image is melted and fixed to the sheet P when the sheet P passes through the fixing nip portion.

The discharging device 60 includes, for example, discharge rollers 62 and 64 which discharge the sheet P having the toner image fixed thereto to the outside of the apparatus.

An example of a printing process that is carried out by the imaging apparatus 1 will be described. When an image signal of a recording target image is input to the imaging apparatus 1, a control unit (or controller) of the imaging apparatus 1 rotates the first roller 11 so that the sheet P stacked on the cassette K is picked up and conveyed. Then, the surface of the image carrier 40 is uniformly charged to a predetermined potential by the charging roller 41 (a charging operation). Then, the surface of the image carrier 40 is irradiated with a laser beam by the exposure unit 42 based on a received image signal so that an electrostatic latent image is formed (an exposing operation).

In the developing device 20, the electrostatic latent image is developed so that a toner image is formed (a developing operation). The toner image formed in this way is primarily transferred from the image carrier 40 to the transfer belt 31 in a region in which the image carrier 40 faces the transfer belt 31 (a transferring operation). The toner images formed on the four image carrier 40 are sequentially layered or superimposed on the transfer belt 31 so that a single composite toner image is formed. Then, the composite toner image is secondarily transferred to the sheet P supplied from the sheet supply device 10 in the transfer nip portion R2 in which the tension roller 37 faces the secondary transfer roller 33.

The sheet P to which the composite toner image is secondarily transferred is conveyed to the fixing device 50. Then, the fixing device 50 melts and fixes the composite toner image to the sheet P by heating and pressing the sheet P between the heating roller 52 and the pressing roller 54 when the sheet P passes through the fixing nip portion (a fixing operation). Then, the sheet P is discharged to the outside of the imaging apparatus 1 by the discharge rollers 62 and 64.

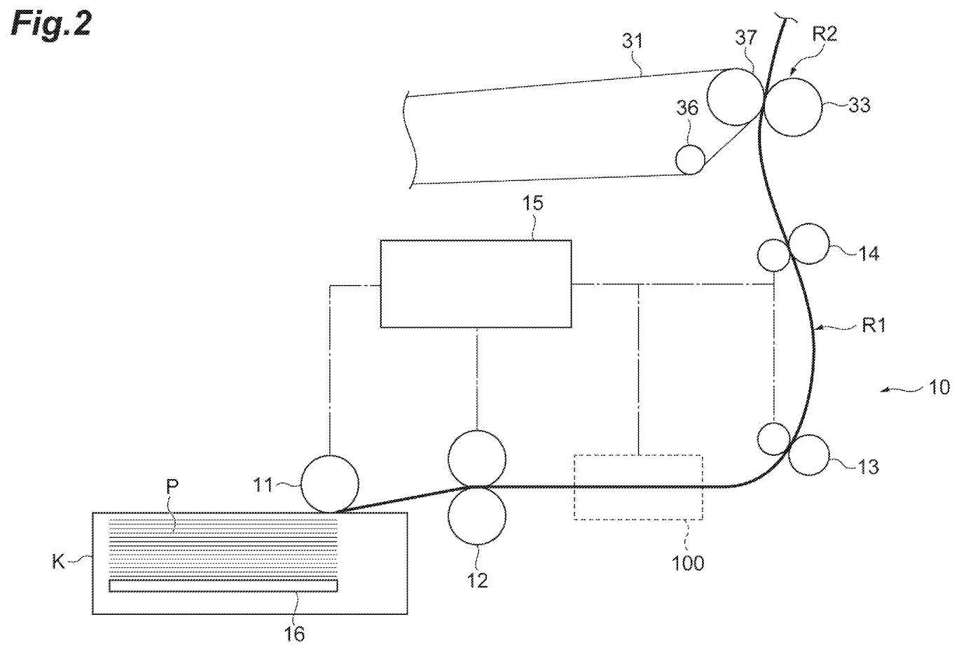

With reference to FIG. 2, the sheet supply device 10 includes a first roller 11, second rollers 12, third rollers 13, and fourth rollers 14, in sequence from an upstream side of the conveyance path R1, in the conveying direction. The first roller 11 is, for example, a pickup roller and is configured as a single roller. The first roller 11 rotates with the sheet P interposed between the pressing member 16 and the first roller so that the sheet P is conveyed toward the second rollers 12. The first roller 11 rotates in a driving manner by, for example, a drive motor. A contact pressure of the first roller 11 with respect to the sheet P, that is, a pressing force between the first roller 11 and the pressing member 16 is variable.

The second rollers 12 may include a pair of rollers which are retard rollers for suppressing the conveying of the plurality of sheets P in an overlapping state. The second rollers 12 rotate with the sheet P interposed therebetween so that the sheet P is conveyed toward the third rollers 13. In some examples, the second rollers 12 include a driving roller rotating in a driving manner by a drive motor and a driven roller rotating in a driven manner in accordance with the rotation of the driving roller. A contact pressure of the second rollers 12 with respect to the sheet P, which may be a pressing force between the pair of rollers constituting the second roller 12, is variable.

The third rollers 13 may include a pair of rollers which are feeding roller. The third rollers 13 rotate with the sheet P interposed therebetween so that the sheet P is conveyed toward the fourth rollers 14. In some examples, the third rollers 13 include a driving roller rotating in a driving manner by a drive motor and a driven roller rotating in a driven manner in accordance with the rotation of driving roller. A contact pressure of the third roller 13 with respect to the sheet P, which may be a pressing force between the pair of rollers constituting the third roller 13, is variable.

The fourth rollers 14 may include a pair of rollers which may be registration rollers (paper stop rollers) that feed the sheet P to the transfer nip portion R2 in accordance with the transfer timing of the transfer device 30 while positioning the sheet P. The fourth rollers 14 convey the sheet P toward the transfer nip portion R2 while rotating with the sheet P interposed therebetween. In some examples, the fourth roller 14 includes a driving roller rotating in a driving manner by a drive motor and a driven roller rotating in a driven manner in accordance with the rotation of the driving roller.

The sheet supply device 10 further includes a controller 15. The controller 15 may be electrically connected to operative components (e.g., the first roller 11, the second rollers 12, the third rollers 13 and the fourth rollers 14) of the sheet supply device 10 to control the operation of the sheet supply device 10. The controller 15 controls, for example, the conveying speed of the sheet P in the sheet supply device 10. For example, the controller 15 may control the movement speed (or conveyance speed) of the sheet P conveyed from the cassette K to the fourth rollers 14 by the first roller 11, the second rollers 12, and/or the third rollers 13. The controller 15 may control, for example, a contact pressure of the sheet P with respect to the first roller 11, the second roller 12, and/or the third roller 13.

The controller 15 may be implemented by, for example, a computer including a processor such as a central processing unit (CPU) and a storage unit (or storage device) such as a read-only memory (ROM) and a random access memory (RAM). The storage unit stores a program for controlling the sheet supply device 10. The storage unit may include, for example, a non-transitory computer-readable storage device (storage medium) that stores the program. The controller 15 may achieve various kinds of control by allowing the processor to read and execute the program.

With reference to FIGS. 1 and 2, the imaging apparatus 1 further includes a stiffness index measurement unit (or stiffness index measurement device) 100 which is a deformation tolerance portion. The stiffness index measurement unit 100 measures a bending amount (a level or degree of the bending) of the sheet P and derives an index indicating the stiffness index of the sheet P on the basis of the measured bending amount. The index indicating the stiffness index may be the stiffness index itself (e.g., a stiffness index value) or a correlated value that is associated with the stiffness index (e.g., a predetermined value corresponding to the stiffness index). Additionally, an example stiffness index may be a value that substantially indicates the stiffness of the sheet P that can be obtained by the method described in JIS P-8125 or a value that can be used as a measurement that is substantially equivalent to the stiffness value.

The example stiffness index measurement unit (or device) 100 is disposed along the conveyance path R1 and may form part of the conveyance path R1. For example, the stiffness index measurement unit 100 may include a frame which can be fixed into the imaging apparatus 1. The stiffness index measurement unit 100 is disposed along the conveyance path R1 at a position between the cassette (the storage portion) K storing the sheet P to the fourth roller 14 in the conveyance path R1. For example, the stiffness index measurement unit 100 may be disposed downstream the cassette K and upstream the fourth roller 14 in the conveying direction from the cassette K to the fourth roller 14. In some examples, the stiffness index measurement unit 100 is disposed between the second roller 12 and the third roller 13.

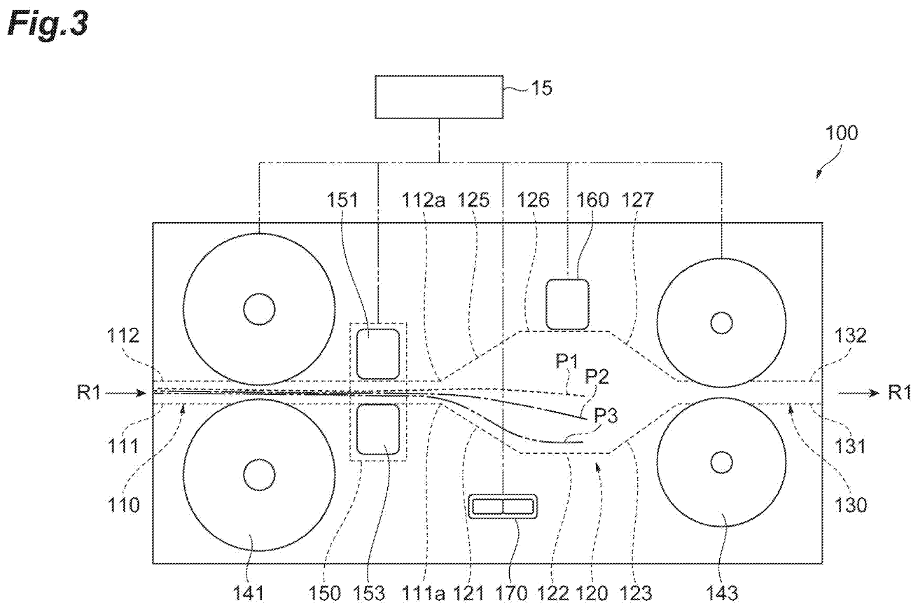

With reference to FIG. 3, an example stiffness index measurement unit (or device) 100 may include an upstream support body (or upstream support) 110, a bending tolerance space 120, a downstream support body (or downstream support) 130, upstream rollers 141, downstream rollers 143, a first sensor (measurement device) 150, a second sensor (measurement device) 160, and an environmental sensor 170. In some examples, the downstream rollers 143 may correspond to the third rollers 13 (FIG. 2).

The upstream support body 110 is disposed upstream of the bending tolerance space 120 in the conveying direction of the sheet P. The upstream support body 110 is a portion which guides the sheet P conveyed along the conveyance path R1 to the bending tolerance space 120. The example upstream support body 110 extends in a substantially horizontal direction (e.g., the upstream support body is substantially disposed along the horizontal direction). For example, the sheet P conveyed along the conveyance path R1 is conveyed to the downstream side along the upstream support body 110 while substantially maintaining a horizontal state. Additionally, the upstream support body 110 of the example illustrated in the drawing includes a pair of upper and lower plate-shaped support members 111 and 112. A gap between the support member 111 and the support member 112 may be sufficiently narrow to suppress the movement (shaking) in the vertical direction of the sheet P conveyed between the support member 111 and the support member 112. For example, the gap is narrower than the bending amount of the sheet P in the bending tolerance space 120 which will be described later. The gap between the support member 111 and the support member 112 may measure about 2 mm or less as an example.

The bending tolerance space (space) 120 is disposed at the downstream of the upstream support body 110 in the conveying direction of the sheet P. The bending tolerance space 120 provides a space extending in a direction intersecting the conveying direction so as to allow the sheet P conveyed along the conveyance path R1 to be bent. The example bending tolerance space 120 extends in a vertical direction so that the sheet P conveyed in the horizontal direction as the conveying direction may be bent by gravity. For example, the bending tolerance space 120 extends in a second direction (a vertical direction as an example) that is angularly offset from a first direction (a horizontal direction as an example) in which the upstream support body 110 extends. Accordingly, the bending tolerance space 120 allows the sheet P to be bent in a direction that is angularly offset from (e.g., a direction that intersects) the conveying direction.

With reference to FIG. 3, the bending tolerance space 120 may be defined by an upstream inclined portion 121, a flat portion 122, and a downstream inclined portion 123. The upstream inclined portion 121 is inclined downward toward the downstream side from a downstream end 111a of the support member 111 of the upstream support body 110. The flat portion 122 is formed horizontally toward the downstream side from the downstream end of the upstream inclined portion 121. The downstream inclined portion 123 is inclined upward toward the downstream side from the downstream end of the flat portion 122. The downstream inclined portion 123 has a function as a guide for redirecting the front edge of the bent sheet P in the conveying direction toward the downstream support body 130.

Further, the bending tolerance space 120 includes an upstream inclined portion 125, a flat portion 126, and a downstream inclined portion 127. The upstream inclined portion 125 is inclined upward toward the downstream side from a downstream end 112a of the support member 112 of the upstream support body 110. The flat portion 126 is formed horizontally toward the downstream side from the downstream end of the upstream inclined portion 125. The downstream inclined portion 127 is inclined downward toward the downstream side from the downstream end of the flat portion 126.

The downstream support body 130 is disposed at the downstream of the bending tolerance space 120 in the conveying direction of the sheet P. The downstream support body 130 is a portion that guides the sheet P conveyed along the conveyance path toward the downstream side of the conveyance path R1. The example downstream support body 130 extends substantially in the horizontal direction. That is, the sheet P conveyed along the conveyance path R1 is conveyed toward the downstream side along the downstream support body 130 while maintaining a substantially horizontal state. Additionally, the downstream support body 130 of the example illustrated in the drawing includes a pair of upper and lower plate-shaped support members 131 and 132.

The upstream rollers 141 conveys the sheet P conveyed in the upstream support body 110 toward the downstream side in the conveying direction. The example upstream rollers 141 includes a pair of rollers disposed at the upper and lower sides. The upstream rollers 141 rotates with the sheet P interposed therebetween so that the sheet P is conveyed toward the bending tolerance space. In some example, the upstream rollers 141 may include a driving roller rotating in a driving manner by a drive motor and a driven roller rotating in a driven manner in accordance with the rotation of the driving roller. The contact pressure of the upstream roller 141 with respect to the sheet P may be variable.

The downstream rollers 143 convey the sheet P conveyed in the downstream support body 130 toward the downstream side in the conveying direction. The example downstream rollers 143 include a pair of rollers disposed at the upper and lower sides. The downstream rollers 143 rotate with the sheet P interposed therebetween so that the sheet P is conveyed toward the downstream side in the conveying direction. In some examples, the downstream rollers 143 may include a driving roller rotating in a driving manner by a drive motor and a driven roller rotating in a driven manner in accordance with the rotation of the driving roller. A contact pressure of the downstream rollers 143 with respect to the sheet P may be variable.

The first sensor (the first ultrasonic sensor) 150 is provided at the entrance (or entry passage) of the bending tolerance space 120 in the stiffness index measurement unit (or device) 100. The first sensor 150 can detect an edge and double feeding of the sheet P and measure the thickness of the sheet P. The first sensor 150 of the example illustrated in the drawing includes an ultrasonic transmitter 151 which transmits an ultrasonic wave and an ultrasonic receiver 153 which receives an ultrasonic wave transmitted from the ultrasonic transmitter 151. The ultrasonic transmitter 151 and the ultrasonic receiver 153 are disposed at a position along the upstream support body 110, downstream the upstream rollers 141 (e.g., between the upstream rollers 141 and the bending tolerance space 120). The ultrasonic transmitter 151 faces the ultrasonic receiver 153 with the conveyance path interposed therebetween. In an example, the ultrasonic transmitter 151 is disposed on the same side as the support member 112 in the upstream support body 110 and the ultrasonic receiver 153 is disposed on the same side as the support member 111 in the upstream support body 110.

In the first sensor 150, the signal received at the ultrasonic receiver 153 varies in response to the presence of the sheet P, the thickness of the sheet P, and the number of the sheets P between the ultrasonic transmitter 151 and the ultrasonic receiver 153. Therefore, the first sensor 150 can detect the edge of the conveyed sheet P based on the received signal. In this case, the first sensor 150 can output a timing at which the leading edge of the sheet P (the downstream end in the conveying direction) is detected as a signal. Further, the first sensor 150 can detect whether the sheet P is conveyed in an overlapping state based on the received signal. Moreover, the first sensor 150 can measure the thickness of the conveyed sheet P based on the received signal.

The second sensor (the second ultrasonic sensor) 160 faces (or is aligned with) the bending tolerance space 120 so as to output an ultrasonic wave to the bending tolerance space 120 in a direction intersecting the conveying direction. The second sensor 160 measures a bending amount of the sheet P conveyed in the bending tolerance space 120. The second sensor 160 of the example illustrated in the drawing includes an ultrasonic transmitter which transmits an ultrasonic wave and an ultrasonic receiver which receives an ultrasonic wave transmitted from the ultrasonic transmitter and reflected by an object located below the ultrasonic transmitter. Further, the second sensor 160 may include an ultrasonic transceiver having an ultrasonic wave transmitting function and an ultrasonic wave receiving function. The second sensor 160 with such a configuration has a function as a distance measurement sensor and can measure a distance to an object.

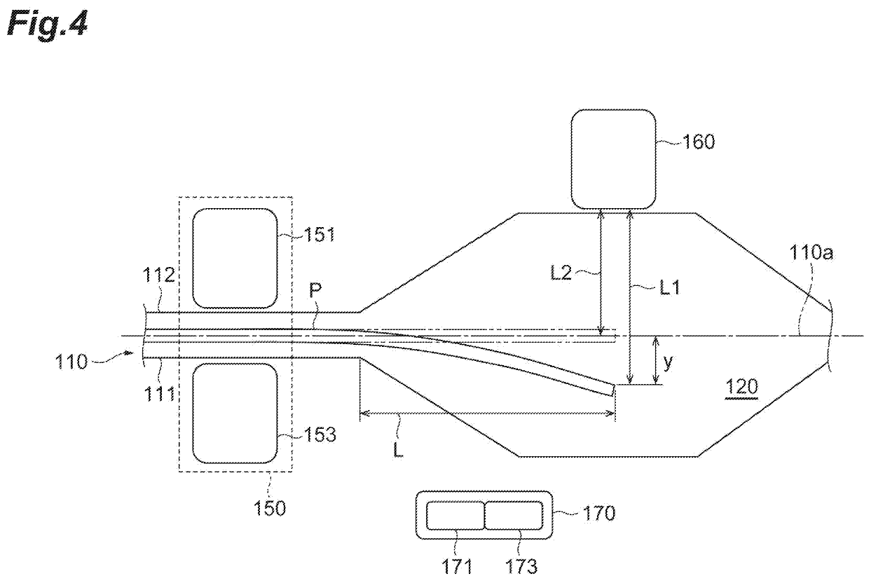

With further reference to FIG. 4, when the sheet P is conveyed along the conveyance path R1, the leading edge of the sheet P reaches a measurement range of the second sensor 160 (for example, a position right below the second sensor 160 or a position that is vertically aligned with the second sensor 160). At this time, the leading edge side of the sheet P is bent downward by gravity according to the stiffness (in accordance with the stiffness index) of the sheet P. The second sensor 160 measures a distance from the second sensor 160 to the sheet P. A bending amount is calculated from a distance measured based on the height position of the second sensor 160 and the height position of the upstream support body 110. As an example, a bending amount y can be calculated by subtracting a distance L2 between the height position of the second sensor 160 and the height position 110a of the upstream support body 110 from a measured distance L1 between the second sensor 160 and the sheet P. The measurement of the second sensor 160 can be performed, for example, in a state in which the sheet P is conveyed. Additionally, the height position 110a of the upstream support body 110 may be the height position of the top surface (or upper surface) of the support member 111 or the height obtained by adding the thickness of the sheet P to the height of the top surface (or upper surface) of the support member 111.

The environmental sensor 170 includes a temperature measurement unit (e.g., a temperature sensor) 171 and a humidity measurement unit 173 (e.g., a humidity sensor). The environmental sensor 170 measures the humidity and the temperature in the vicinity of the first sensor 150 inside the stiffness index measurement unit (or device) 100, in the vicinity of the second sensor 160, and the inside of the bending tolerance space 120. The example environmental sensor 170 is disposed at a position within a predetermined distance from the first sensor 150, the second sensor 160, and the bending tolerance space 120 according to the measurement performance of the environmental sensor 170. The temperature measured by the environmental sensor 170 is used in the ultrasonic wave output gain correction to compensate for variations in the ultrasonic wave output gain due to the temperatures in the first sensor 150 and in the second sensor 160. Further, the humidity measured by the environmental sensor 170 is used in the humidity correction in the stiffness index deriving operation to be described later.

In an example with reference to FIG. 3, the upstream roller 141, the downstream roller 143, the first sensor 150, the second sensor 160, and the environmental sensor 170 are connected to the controller 15. That is, the controller 15 controls the driving of the upstream roller 141 and the downstream roller 143 while receiving signals from the first sensor 150, the second sensor 160, and the environmental sensor 170. Additionally, the stiffness index measurement unit (or device) 100 may perform a control relating to the stiffness index measurement unit 100 by including a separate controller capable of communicating with the controller 15.

An example method of calculating the stiffness index in the stiffness index measurement unit 100 will be described. In the example stiffness index measurement unit 100, the stiffness index of the sheet P is derived based on the conveying speed of the sheet P using the sheet supply device 10, the detection timing of the leading edge of the sheet P, the bending amount of the sheet P, and the humidity. For example, the stiffness index of the sheet P can be derived by the controller 15.

In the example stiffness index measurement unit 100 illustrated in FIG. 3, when the sheet P conveyed along the upstream support body 110 reaches the bending tolerance space 120, the leading edge side of the sheet P can be bent downward under the influence of gravity. The bending amount of the sheet P changes in response to the stiffness index of the sheet P. For example, given a sheet P1, a sheet P2, and a sheet P3 sequenced in decreasing order of thickness and basis weight (grammage), where the sheet P3 has the lowest thickness and lowest basis weight and the sheet P1 has the greatest thickness and greatest basis weight, the bending amount of the sheet P1 is the greatest and the bending amount of the sheet P3 is the lowest under the same environment (e.g., the same environmental conditions).

In the example stiffness index measurement unit (or device) 100, an index indicating the stiffness index of the sheet P is determined in response to a level of the measured bending amount of the sheet P. As described above, according to examples, the stiffness index may correspond to a value that substantially indicates the stiffness of the sheet P obtained by the method described in JIS P-8125. According to other examples, the stiffness index is calculated in the example stiffness index measurement unit 100, based on the following equation.

Stiffness index=α(wL4/8y×9.81)

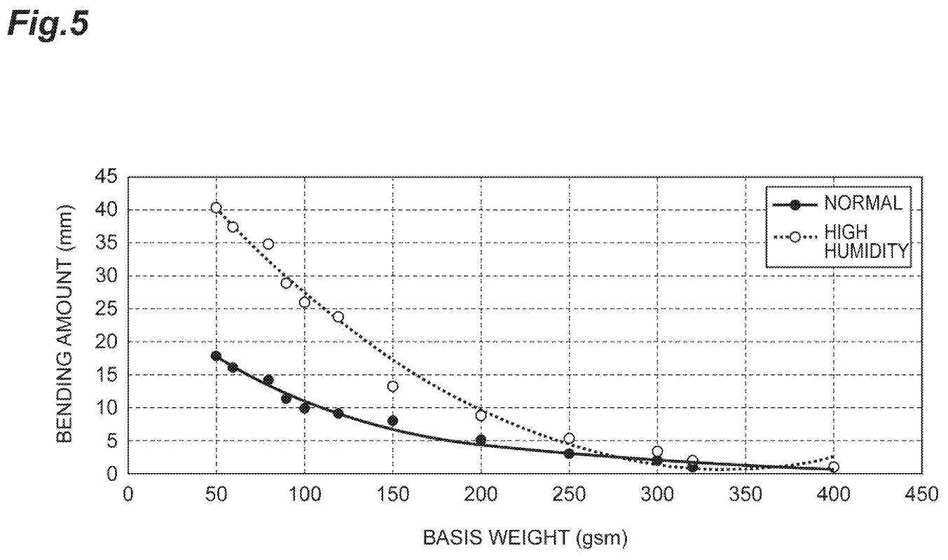

In the above-described equation, w indicates a basis weight (gsm), L indicates a length or distance (m) from the downstream end of the upstream support body 110 to the leading edge of the sheet P, y indicates the bending amount (m), and α indicates a humidity correction coefficient. FIG. 4 is a partially enlarged view of the stiffness index measurement unit. FIG. 5 is a graph showing a relationship between the bending amount y and the basis weight w of the sheet P. FIG. 5 shows a curve labeled NORMAL, representing a bending amount measured under a reference humidity environment in the measurement of the stiffness index and a curve labeled HIGH HUMIDITY, representing a bending amount (a high humidity) measured in a humidity environment higher than the reference humidity environment.

With reference to FIG. 5, there is a tendency that the bending amount y of the sheet P decreases as the basis weight w of the sheet P increases. Thus, the basis weight w of the sheet P can be estimated based on the measured bending amount of the sheet P. The example controller 15 has a lookup table in which the measured bending amount y is correlated with the basis weight w and the basis weight w is estimated based on the bending amount y by referring to the lookup table. Additionally, since a relationship between the bending amount y and the basis weight w is dependent on the humidity environment, a lookup table may be prepared for each of different humidity levels.

The length L may be calculated based on the timing at which the first sensor 150 detects the leading edge of the sheet P and the conveying speed of the sheet P in the sheet supply device 10 (including the upstream roller 141). In an example, when the leading edge of the sheet P reaches the position of the first sensor 150 along the conveyance path R1, the leading edge of the sheet P is detected by the first sensor 150. In this case, the position of the sheet P at an arbitrary time can be calculated based on the edge detection timing and the conveying speed of the sheet P. The length L may be calculated based on the calculated position of the sheet P. Further, the timing at which the leading edge of the sheet P reaches a measurement range of the second sensor 160 (e.g., a position directly underneath or a position that is vertically aligned with the second sensor 160) can be calculated. For that reason, when the stiffness index is measured based on the bending amount y at the time in which the leading edge of the sheet P passes through a position that is vertically aligned (e.g., directly below) the second sensor 160, the length L may be a distance from the downstream end of the upstream support body 110 to the second sensor 160 in the conveying direction.

With reference to FIG. 5, since the bending amount y of the sheet P changes due to the environment humidity, the measurement of the bending amount y is initially carried out under a predetermined humidity environment as a reference. When the humidity is not considered, the stiffness index may be calculated from the equation below. In this case, since the bending amount y is largely dependent on the humidity, the calculated stiffness index changes in response to the humidity environment even in the same sheet P.

Stiffness index=wL4/8y×9.81

Under an actual printing environment, it is difficult to maintain humidity constant. Therefore, in the example stiffness index measurement unit (or device) 100, the stiffness index is corrected by using the humidity correction coefficient α. The humidity correction coefficient α is a coefficient for converting the stiffness index measured under different environment humidity levels, into the stiffness index under the reference humidity environment. For example, the controller 15 has a lookup table in which the humidity and the bending amount y are correlated with the humidity correction coefficient α and determines the humidity correction coefficient α based on the lookup table.

An example control process carried out by the imaging apparatus 1 will be described. Based on the stiffness index of the sheet P measured by the stiffness index measurement unit 100, the controller 15 can adjust a printing parameter. For example, the controller 15 may adjust the conveying speed of the sheet P using the sheet supply device 10. The example controller 15 can adjust the conveying speed of the sheet P by changing the rotation speed of the first roller 11, the third roller 13, the upstream roller 141, and the downstream roller 143.

In an example, the controller 15 may divide the measured stiffness index into a plurality of levels and adjust the conveying speed in response to the level. For example, the controller 15 may classify the sheet P into four levels (stiffness index levels 1 to 4) based on the magnitude (or scale) of the measured stiffness index. For example, when the stiffness index of the sheet is relatively low, and an associated stiffness index level 1 is determined, the sheet conveying speed may be controlled to 100%. Further, when the stiffness index of the sheet is medium, and an associated stiffness index level 2 is determined, the sheet conveying speed may be controlled to 75%. Further, when the stiffness index of the sheet is relatively high, and an associated stiffness index level 3 is determined, the sheet conveying speed may be controlled to 50%. Moreover, when the stiffness index of the sheet is even higher, and an associated stiffness index level 4 is determined, the sheet conveying speed may be set to 0%, to stop the sheet supply device 10 due to a certain operation error detected, or the like.

Further, the controller 15 may adjust the heating temperature of the heating roller 52 in the fixing device 50 in response to the determined stiffness index level. For example, the heating temperature may be controlled to 50% for the stiffness index level 1 associated with a low stiffness index, to 75% for the stiffness index level 2 associated with a medium stiffness index, and to 75% for the stiffness index level 3 associated with a high stiffness index. Accordingly, when the stiffness index of the sheet is low and the stiffness index level 1 is determined, the heating temperature may be controlled to 50%; when the stiffness index of the sheet is medium and the stiffness index level 2 is determined, the heating temperature may be controlled to 75%; and when the stiffness index of the sheet is high and the stiffness index level 3 is determined, the heating temperature may be controlled to 100%.

In some examples, the controller 15 may adjust the passage speed of the sheet P in the transfer device 30 (the transfer nip portion R2) in response to the determined stiffness index level. For example, the passage speed may be controlled to 100% for the stiffness index level 1 associated with a low stiffness index, to 75% for the stiffness index level 2 associated with a medium stiffness index, and to 50% for the stiffness index level 3 associated with a high stiffness index. Accordingly, when the stiffness index of the sheet is low and the stiffness index level 1 is determined, the passage speed may be controlled to 100%; when the stiffness index of the sheet is medium and the stiffness index level 2 is determined, the passage speed may be controlled to 75%; and when the stiffness index of the sheet is large and the stiffness index level 3 is determined, the passage speed may be controlled to 50%. Additionally, the passage speed of the sheet P in the transfer device 30 can be performed by the control of the secondary transfer roller 33.

As described above, in the example imaging apparatus 1, the bending amount of the sheet P conveyed along the conveyance path is measured in order to acquire the thickness, the basis weight w, the stiffness index, and the like of the sheet P based on the bending amount y. For example, although the example control of the imaging apparatus may include a method of appropriately maintaining a printing parameter based on the basis weight and the like of the sheet, input by a user, there may be occurrences where the user erroneously inputs values such as the basis weight, or where a printing parameter not suitable for the sheet due to variations in the quality of the sheets, is set. In the example imaging apparatus 1, since the actual stiffness index and the like of the sheet can be acquired based on the measured bending amount, the printing parameter may be set more suitable based on the stiffness index and the like. Additionally, the printing parameter may include any one or more parameters among the passage speed of the sheet P of the transfer device 30, and the heating temperature of the fixing device 50, for example. Since such a printing parameter is adjusted, a printing operation suitable for the quality of the actual sheet (actual sheet quality), can be performed.

In this case, for example, the printing parameter of the sheet P can be adjusted in response to the stiffness index of the sheet P and the occurrence of a jam of the sheet P in the sheet supply device 10 can be suppressed. Since the occurrence of jams is suppressed or reduced, the number of maintenance interventions can be decreased and a maintenance plan can be created with better accuracy, in order to achieve a decrease in operation cost.

According to some examples, the example bending tolerance space 120 extends in a second direction that is angularly offset from a first direction in which the upstream support body 110 extends so that the sheet P is bent by gravity. In some examples, the upstream support body 110 is disposed along a substantially horizontal direction and the bending tolerance space 120 is wider in the vertical direction relative to a width of the upstream support body 110 between the lower plate-shaped support member 111 and the upper plate-shaped support member 112. In this configuration, the sheet P is conveyed in a state in which one surface faces upward in the vertical direction and the other surface faces downward in the vertical direction. The sheet P is bent to the other surface by the influence of gravity, without using any dedicated device for bending the sheet P, and a device can have a more simple configuration. Further, since the sheet P is bent by gravity, a condition when the sheet P is bent due to a deterioration or the like of the device does not change.

The example stiffness index measurement unit (or device) 100 includes the downstream inclined portion 123 as a guide for redirecting the bent sheet P toward the downstream support body 130. In this configuration, the sheet P which is temporarily bent in the bending tolerance space 120, is more smoothly conveyed toward the downstream support body 130, in order to suppress or inhibit jamming of the sheet P inside the stiffness index measurement unit 100.

The first sensor 150 provided at the entrance (e.g., entry passage) of the stiffness index measurement unit 100 detects a timing at which the sheet P is conveyed to the stiffness index measurement unit 100, in order to more easily estimate or determine the conveying position of the sheet P in the stiffness index measurement unit 100, and to minimize the occurrence of an error when estimating the conveying position.

The second sensor 160 provided to face the bending tolerance space 120 is a distance measurement sensor that measures a distance to the sheet P in a direction intersecting the conveying direction of the sheet P, in order to calculate the bending amount based on the measured distance from the second sensor 160 to the sheet P.

The first sensor 150 and the second sensor 160 may include ultrasonic sensors, to carry out a more stable measurement without the influence of the color of the sheet P.

The example imaging apparatus 1 includes the environmental sensor 170 which measures the humidity inside the stiffness index measurement unit 100, in order to calculate the stiffness index from the bending amount in consideration of the influence of the humidity at the time of determining the stiffness index of the sheet P based on a level of the measured bending amount.

The stiffness index measurement unit 100 is disposed downstream the cassette K and upstream the fourth roller 14 in the conveying direction from the cassette K to the fourth roller (the registration roller) 14, in order to adjust the printing parameter of the sheet P before the sheet P is conveyed to the transfer device 30.

It is to be understood that not all aspects, advantages and features described herein may necessarily be achieved by, or included in, any one particular example. Indeed, having described and illustrated various examples herein, it should be apparent that other examples may be modified in arrangement and detail is omitted.

For example, although examples have been described in which the basis weight w is derived from the bending amount y measured by the second sensor 160, the basis weight w may be acquired according to other methods. For example, the basis weight w may be input by a user. In this case, the imaging apparatus 1 may include an input system (e.g., a user interface device) for receiving the basis weight w input by the user. The controller 15 can acquire the value of the basis weight w input by the user and calculate the stiffness index of the sheet P by using the value of the acquired basis weight w.

In some examples, as described above, the thickness of the sheet P can be detected by the first sensor 150. Since the thickness of the sheet P is correlated with the basis weight w, the controller 15 may estimate the basis weight w of the sheet P from the measured thickness of the sheet P. In this case, the controller 15 may include or may access a lookup table in which the thickness of the sheet P is correlated with the basis weight w of the sheet P. The controller 15 can acquire the value of the basis weight w estimated from the thickness and calculate the stiffness index of the sheet P based on the value of the acquired basis weight w.

Further, when the basis weight is acquired from an input by the user, the basis weight estimated from the bending amount may be compared with the basis weight input by the user. Similarly, when the basis weight is estimated based on the thickness of the sheet, the basis weight estimated from the bending amount may be compared with the basis weight estimated from the thickness. Further, the basis weight estimated from the thickness may be compared with the basis weight input by the user. In such a case, when there is a relatively large difference between the basis weights as a result of a comparison (e.g., when the difference exceeds a threshold), a warning message may be output to indicate that an error. Accordingly, a verification system may compare data of different sources.

Although according to some examples, the first sensor 150 and the second sensor 160 include the ultrasonic sensor as the measurement device, the measurement device may include a sensor of a different type. For example, the first sensor 150 may detect at least the edge of the conveyed sheet. As an example, the first sensor 150 may be an optical sensor for detecting the existence of an object. Further, the second sensor 160 may detect the bending amount of the conveyed sheet. As an example, the second sensor 160 may be an optical distance measurement sensor which measures a distance to an object.

In addition, although the sheet has been described as a paper sheet material in some examples, the sheet material may include another sheet-shaped material. For example, the sheet material may include a plastic film such as an overhead projector (OHP) sheet (e.g., a transparent film used for an overhead projector). Additionally, when an OHP sheet is used as a sheet material, since the bending amount of the OHP sheet is not influenced by the humidity, the stiffness index can be calculated without using the humidity correction coefficient α.

In addition, although examples have been described in which the upstream support body 110 extends in the horizontal direction along the conveying direction, the upstream support body 110 may extend while being inclined at an angle relative to the horizontal direction. Accordingly, the bending of the sheet may be measured relative to an initial position when the sheet is bent due to gravity, rather than from a horizontal direction. For example, when the upstream support body 110 extends along a plane intersecting the vertical direction, the conveyed sheet can be bent in one direction due to the influence of gravity. In an example, the displacement amount of the sheet from the initial position can be defined as the bending amount. In this case, the initial position may be a position which can be determined based on the position of the sheet in a state in which the sheet is not bent. The example initial position may be a position of the conveyance path with the assumption that the sheet is not bent in the conveyance path.

1. An imaging system comprising:
a conveyor device to convey a sheet material along a conveyance path;
a deformation tolerance portion located along the conveyance path, wherein the deformation tolerance portion includes a space to accommodate a bending of the sheet material conveyed; and
a measurement device located in the deformation tolerance portion, to measure a bending amount of the sheet material.

2. The imaging system according to claim 1, wherein the space of the deformation tolerance portion extends in a vertical direction to accommodate the sheet material to bend by gravity.

3. The imaging system according to claim 1, comprising:
an upstream support located upstream the space in a conveying direction of the sheet material, wherein the upstream support extends in a first direction,
wherein the space of the deformation tolerance portion extends in the first direction and in a second direction that intersects the first direction.

4. The imaging system according to claim 3, wherein the first direction is substantially horizontal.

5. The imaging system according to claim 1, comprising:
a downstream support located downstream the space in a conveying direction of the sheet material,
wherein the deformation tolerance portion includes a guide to redirect the sheet material having been bent toward the downstream support.

6. The imaging system according to claim 1, wherein the measurement device includes a sheet detection sensor located at an entrance of the deformation tolerance portion, to detect a timing at which the sheet material is conveyed to the deformation tolerance portion.

7. The imaging system according to claim 6, wherein the sheet detection sensor is an ultrasonic sensor.

8. The imaging system according to claim 1,
wherein the measurement device includes a bend detection sensor that faces the deformation tolerance portion,
wherein the bend detection sensor is a distance measurement sensor to measure a distance from the bend detection sensor to the sheet material in a direction that intersects a conveying direction of the sheet material in the deformation tolerance portion, and
the measurement device to calculate the bending amount based on the distance between the bend detection sensor and the sheet material.

9. The imaging system according to claim 8, wherein the bend detection sensor is an ultrasonic sensor.

10. The imaging system according to claim 1, comprising:
an environmental sensor to measure a humidity inside the deformation tolerance portion.

11. The imaging system according to claim 1, comprising:
a controller that is communicatively coupled to the measurement device to determine a stiffness index of the sheet material based on the bending amount measured by the measurement device.

12. The imaging system according to claim 11,
the controller to adjust a printing parameter in the imaging system based on the stiffness index of the sheet material.

13. The imaging system according to claim 12, comprising:
a transfer device to transfer a toner image to the sheet material; and
a fixing device to heat the toner image transferred to the sheet material to fix the toner image to the sheet material,
wherein the printing parameter includes at least one parameter selected from the group consisting of: a passage speed of the sheet material in the transfer device, and a heating temperature in the fixing device.

14. The imaging system according to claim 1, comprising:
a storage portion to store the sheet material; and
a registration roller to feed the sheet material according to a transfer timing,
wherein the deformation tolerance portion is located downstream the storage portion and upstream the registration roller in a conveying direction of the sheet material from the storage portion to the registration roller.

15. An imaging system comprising:
a cassette to store a sheet material;
a conveyor device to convey the sheet material along a conveyance path according to a conveying speed;
a deformation tolerance portion located along the conveyance path to accommodate a bending of the sheet material in a direction that is angularly offset from the conveyance path;
a first ultrasonic sensor located at an entrance of the deformation tolerance portion, to detect a leading edge of the sheet material at a detection timing;
a second ultrasonic sensor located in the deformation tolerance portion, to measure a bending amount of the sheet material;
an environmental sensor to measure a humidity inside the deformation tolerance portion; and
a controller to determine a stiffness index of the sheet material based on the conveying speed of the conveyor device, the detection timing of the leading edge of the sheet material, the bending amount of the sheet material, and the humidity inside the deformation tolerance portion.
